(19) United States
(12) Patent Application Publication
(10) Pub. No.: US 2007/0209191 A1
(43) Pub. Date: Sep. 13, 2007

(54) Method for forming a golf club head or portion thereof with reduced porosity using hot isostatic pressing

(76) Inventor: Scott A. Rice, San Diego, CA (US)

Correspondence Address: ACUSHNET COMPANY, 333 BRIDGE STREET, P. O. BOX 965, FAIRHAVEN, MA, 02719, US

(21) Appl. No.: 11/369,697

(22) Filed: Mar. 7, 2006

(51) Int. Cl. B23P 17/00

(52) U.S. Cl. 29/527.5

(57) ABSTRACT

A process for making a golf club head or a portion thereof with reduced internal flaws and/or improved mechanical properties is disclosed.

### FIELD OF THE INVENTION

The present invention relates to an improved golf club and a method for making the golf club of portion thereof, in which hot isostatic pressing (HIP) is used.

### BACKGROUND

The complexities of golf club design are known. The specifications for each component of the club (i.e., the club head, shaft, grip, and subcomponents thereof) directly impact the performance of the club. Thus, by varying the design specifications, a golf club can be tailored to have specific performance characteristics.

The design of club heads has long been studied. Among the more prominent considerations in club head design are loft, lie, face angle, horizontal face bulge, vertical face roll, center of gravity, inertia, material selection, and overall head weight. While this basic set of criteria is generally the focus of golf club designers, several other design aspects must also be addressed. The interior design of the club head may be tailored to achieve particular characteristics, such as the inclusion of hosel or shaft attachment means, perimeter weights on the club head, and fillers within the hollow club heads.

Golf club heads must also be strong to withstand the repeated impacts that occur during collisions between the golf club and the golf balls. The loading that occurs during this transient event can create a peak force of over 2,000 lbs. Thus, a major challenge is designing the club face and body to resist permanent deformation or failure by material yield or fracture. Conventional hollow metal wood drivers made from titanium typically have a uniform face thickness exceeding about 2.5 mm to ensure structural integrity of the club head.

Players generally seek a metal wood driver and golf ball combination that delivers maximum distance and landing accuracy. The distance a ball travels after impact is dictated by the magnitude and direction of the ball's initial velocity and the ball's rotational velocity or spin. Environmental conditions, including atmospheric pressure, humidity, temperature, and wind speed, further influence the ball's flight. However, these environmental effects are beyond the control of the golf equipment designers. Golf ball landing accuracy is driven by a number of factors as well. Some of these factors are attributed to club head design, such as center of gravity and club face flexibility.

Generally, golf ball travel distance is a function of the total kinetic energy imparted to the ball during impact with the club head, neglecting environmental effects. During impact, kinetic energy is transferred from the club and stored as elastic strain energy in the club head and as viscoelastic strain energy in the ball. After impact, the stored energy in the ball and in the club is transformed back into kinetic energy in the form of translational and rotational velocity of the ball, as well as the club. Since the collision is not perfectly elastic, a portion of energy is dissipated in club head vibration and in viscoelastic relaxation of the ball. Viscoelastic relaxation is a material property of the polymeric materials used in all manufactured golf balls.

Viscoelastic relaxation of the ball is a parasitic energy source, which is dependent upon the rate of deformation. To minimize this effect, the rate of deformation should be reduced. This may be accomplished by allowing more club face deformation during impact. Since metallic deformation may be substantially elastic, the strain energy stored in the club face is returned to the ball after impact thereby increasing the ball's outbound velocity after impact. Therefore, there remains a need in the art to improve the elastic behavior of the hitting face.

Typically, club heads and other parts of golf clubs are made by lost wax or investment casting techniques, which permit the casting of complex shapes found beneficial in golf club technology, because a ceramic material forming a mold is formed by dipping a wax master impression repeatedly into a ceramic slurry with drying periods in-between and with a silica coating that permits undercutting and abrupt surface changes almost without limitation, since the wax is melted from the interior of the ceramic mold after complete hardening.

Investment casting techniques, innovated in the late 1960s, improved the design, construction and performance of golf club heads. Investment casting enables the molder and tool designer to form challenging geometries that were not possible in prior manufacturing techniques, such as forgings. The repetition of forging impacts and the necessity for progressive tooling render the forging process relatively more expensive than the investment casting process. Recent improvements in forging technology can produce parts challenging surface contours, albeit at considerable expense. Investment casting processes were adopted in the 1980s to manufacture wood-type metal club heads because these clubs required interior undercuts, thin walls, and other difficult geometry.

Examples of investment casting processes for use in making golf clubs, or portions thereof, can be found, for example, in U.S. Patent Publication Application No. 2005/0140050 A1 and in U.S. Pat. No. 6,979,720.

However, investment casting processes may leave ceramic particles and wax residue on the cast part. Investment casting processes can also produce cast parts that have relatively high of internal porosity and other internal flaws. Porosity and other flaws in the materials used to make golf club heads, especially on the hitting face, can depart from ideal properties.

As such, there remains a need in the art for additional techniques for effectively removing flaws such as porosity in golf club head materials, particularly on the hitting face, where flaws can detrimentally affect impact performance.

### SUMMARY OF THE INVENTION

The present invention is directed to a method for forming a cast metal component of a golf club. This method comprises the steps of (i) providing the cast metal component, (ii) modifying the surface of the cast metal component to form a surface-modified cast metal component; and (iii) treating the cast metal component in a hot isostatic pressing process to form a bulk-modified cast metal component.

The surface modification step can be a chemical milling process or a chemical mechanical polishing step. The cast metal component can be a club head insert, a face insert, an iron club head, a driver club head, or a putter.

The hot isostatic pressing process preferably occurs at an elevated temperature, at an elevated pressure, in an inert atmosphere, and for a period of time, such that at least one of the following conditions is satisfied:
1. the elevated temperature is from about 800° C. to about 1200° C.;
2. the increased isostatic pressure is from about 400 kg/cm² to about 2000 kg/cm²;
3. the period of exposure time at the elevated temperature and pressure is from about 0.5 hours to about 5 hours; and
4. the inert atmosphere comprises argon.

The hot isostatic pressing step advantageously minimizes at least one of the following flaws in the cast metal component: voids, porosity, undesirable metallic phases, undesirable ceramic phases, dislocation stresses, extensive grain boundaries, and combinations thereof. The bulk-modified cast metal component also advantageously exhibits increases in at least one of the following mechanical properties: tensile strength, flexural strength, toughness, impact resistance, low-cycle fatigue resistance, high-cycle fatigue resistance, creep life, strain-to-break, rupture stress, and combinations thereof.

### BRIEF DESCRIPTION OF THE DRAWINGS

Preferred features of the present invention are disclosed in the accompanying drawings, wherein similar reference characters denote similar elements throughout the several views, and wherein:

FIG. 1 is a front view of an exemplary golf club head;

FIG. 2 is a front, exploded view of another exemplary golf club head showing a club body and a club head insert.

FIG. 3 is a front plan view of another embodiment of a club head insert; and

FIG. 4 is a front exploded view of another exemplary club head showing a club head and another club head insert.

### DETAILED DESCRIPTION OF THE PREFERRED EMBODIMENTS

One aspect of the invention relates to a method for forming a golf club head or a portion thereof. Having been provided with the cast metal component, e.g., whether in the form of a golf club head insert or an entire golf club head, the method according to the invention includes, but is not limited to, the steps of: modifying the surface of the cast metal component, e.g., via a chemical milling process; and removing flaws in the bulk of the cast metal component, e.g., using a hot isostatic pressing (HIP) process. Advantageously, cast metal components treated using the method according to the invention need little, if any, post-processing (e.g., finishing, machining, post-sizing, coining, and the like, and combinations thereof) following the bulk flaw removal step.

In one preferred embodiment, the cast metal component of the invention comprises titanium. In another preferred embodiment, the cast metal component is made from titanium or an alloy containing predominantly titanium. In another embodiment, the cast metal component is made from stainless steel, aluminum, copper, nickel, tungsten or magnesium, among others.

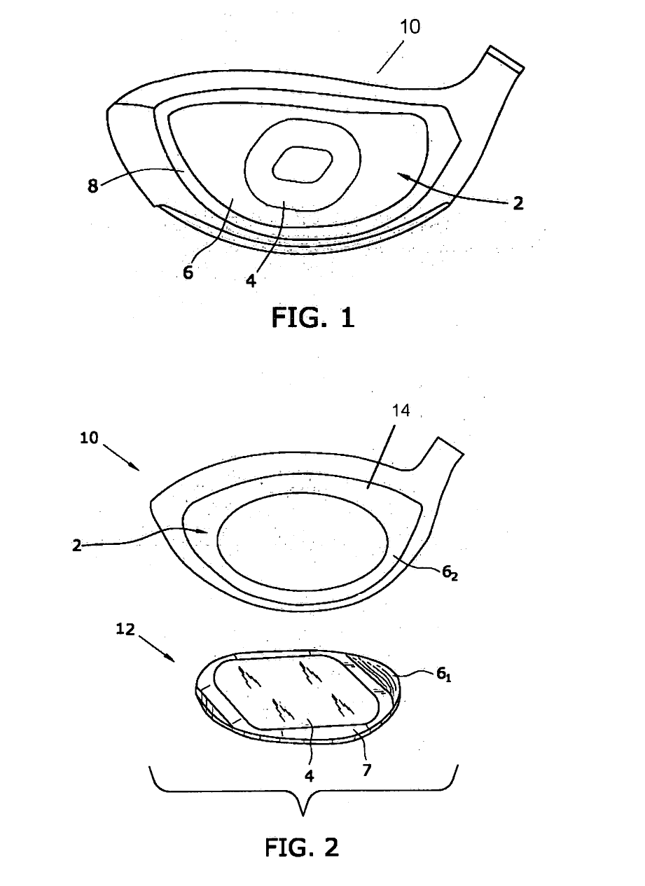

FIG. 1 shows golf club head 10 having hitting face 2. Hitting face 2 generally includes a central zone 4, a surrounding intermediate zone 6, and an optional perimeter zone 8. In one embodiment, the area of central zone 4 comprises less than about 15% of the total area of hitting face 2, and preferably less than about 10% of the total area of hitting face 2. These zones are protruding from the back of hitting face 2, leaving the front smooth to impact golf balls.

Central zone 4 is relatively rigid, and intermediate zone 6 is relatively flexible so that, upon ball impact, intermediate zone 6 of face 2 deforms, i.e., provides a desirable spring-like effect, to provide high ball velocity, while central zone 4 is substantially undeformed so that the ball flies on-target. Thus, upon ball impact the deformation of intermediate zone 6 allows central zone 4 to move into and out of club head 10 as a unit. Surrounding intermediate zone 6 is optional perimeter zone 8.

Generally, central zone 4 has generally uniform thickness and is the thickest portion of hitting face 2. Alternatively, central zone 4 comprises more than one zone or one thickness. The adjacent intermediate zone 6 has a continuously tapering thickness from the perimeter of hitting face 2 toward central zone 4. Alternatively, the thickness of intermediate zone 6 may be substantially uniform. Central zone 4 may include ribs (not shown) for structural support. The thickness of optional perimeter zone 8 is preferably different than the thickness of intermediate zone 6 and may be substantially constant. Hitting face 2 with its relatively complex geometry can advantageously be made by the process of present invention.

Referring to FIG. 2, another example of hitting face 2 is shown. Hitting face 2 includes a face insert 12 and face support 14. Face insert 12 fits into a similarly shaped opening in face support 14 and is affixed therewithin by any method, such as by welding, fusion bonding or HIP. Central zone 4, as shown, has a generally rhombus shape as shown in FIGS. 1 and 2. Intermediate zone 6, designated as 6₁ and 6₂, can be disposed partially on face insert 12 and partially on face support 14. A transition zone 7 having variable thickness is disposed between central zone 4 and intermediate zone 6. Preferably, the thickness of transition zone 7 matches the thickness of central zone 4 where transition zone 7 and central zone 4 meet. Transition zone 7 then tapers to the reduced thickness of intermediate zone 6. This tapering of transition zone 7 reduces any local stress-strain caused by impacts with golf balls due to abrupt changes in thickness. Face insert 12 and the rest of the club head shown in FIG. 2 can be made in accordance to the present invention, described below.

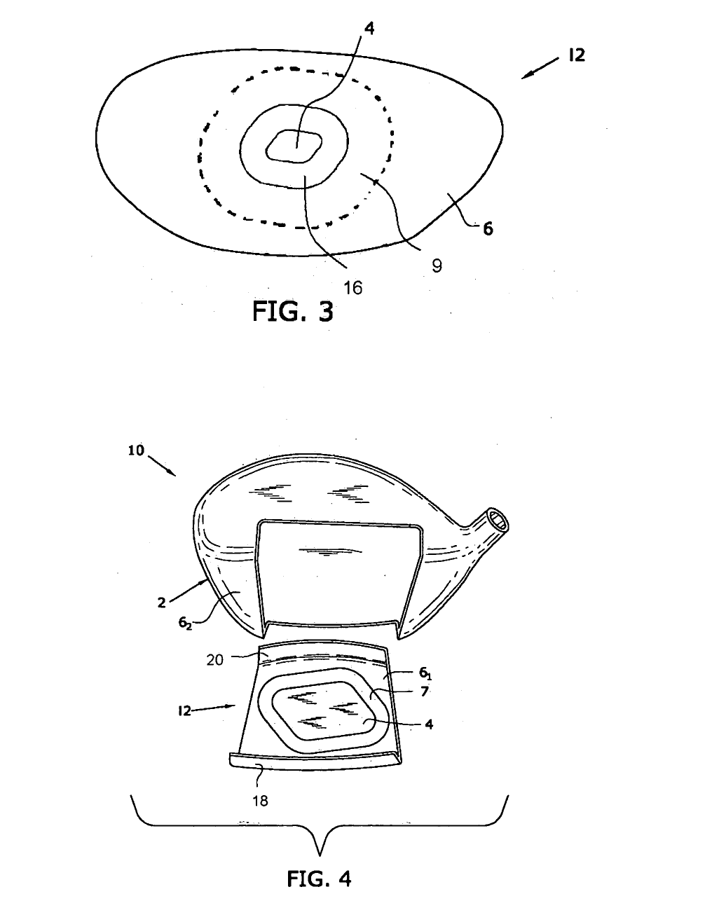

Referring to FIG. 3, an alternate embodiment of hitting face insert 12 is shown. FIG. 3 illustrates another unique geometry of face insert 12. In this embodiment, central zone 4 has substantially a rhombus shape and is surrounded by tapered zone 16 and then by outer zone 9, which may have a substantially constant thickness. Intermediate zone 6 completes face insert 12.

Referring to FIG. 4, yet another embodiment of face insert 12, similar to the hitting face shown in FIG. 2, with a rhombus shaped central zone 4 and transition zone 7. Face insert 12 also has an intermediate zone 6, a partial crown portion 18, and a partial sole portion 20. Partial crown portion 18 and partial sole portion 20 add more complexity to the face insert's geometry.

Preferably, club heads 10 and/or face inserts 12 are formed by investment casting. Under certain circumstances, investment casting does not sufficiently eliminate porosity within these parts, and it may leave undesirable debris on/near the surface of the cast part. As a result, surface modification of the cast part and a bulk flaw removal of the cast part are desirable.

In one embodiment, the surface modification step includes and/or consists essentially of chemical milling on the surface of the cast parts. In another embodiment, the surface modification step includes and/or consists essentially of physical/mechanical milling. In yet another embodiment, the surface modification step includes and/or consists essentially of chemical mechanical polishing (CMP). CMP is a method of fabricating substantially planar or smooth surfaces by selectively removing topographical features. Generally, an object to be polished is rotated against a polishing pad in the presence of pressurized slurry. The slurry typically consists of abrasive particles in an alkaline medium. The slurry feed rate, velocity, pressure, temperature, and pH of the medium, as well as abrasive particle size and material, and pad elasticity and hardness control the effectiveness of CMP.

Modifying the surface of cast metal components removes dirt, grit, impurities, undesirable metallic and/or ceramic phases, or other undesirable elements on the surface of the cast metal component. Additionally or alternately, modifying the surface may create whatever type of surface effects is desired on the cast metal component, e.g., a smooth surface, a textured surface, a patterned surface, or the like, or a combination thereof.

In one embodiment, after the surface modification step, the bulk flaw removal step is carried out to improve the strength of the part. The bulk flaw removal step includes and/or consists essentially of hot isostatic pressing (HIP). HIP involves exposing the cast metal component to an elevated temperature, though not as high as the melting temperature of the metal, in an inert atmosphere at an increased isostatic pressure for a period of time. In another embodiment, the bulk flaw removal step can include liquid HIP, where the inert gas is replaced by molten salt.

The HIP process reduces and/or eliminates internal microshrinkage of cast metal/alloy parts and/or to densify materials. The HIP process improves mechanical properties, e.g., fatigue strength, fatigue life, ductility, and the like, as well as increased workability. The HIP process can also significantly reduce variation in mechanical properties within the parts.

The HIP process can also form near-net shaped parts that require little machining afterward, particularly in the cases of nickel-based and titanium-based alloys. The HIP process along with the casting process are particularly suited to form parts whose dimensions and geometries are difficult to form using other conventional processing technology.

The HIP process can also join or bond different parts of the golf club or golf club head. For instance, a HIP process can be used to affix face insert 12 to the remainder of a golf club head 10. One benefit of HIP bonding, particularly in golf clubs and portions of golf clubs, is that two normally incompatible materials (e.g., metals/alloys with ceramics) can be joined together. The HIP process can also be used to density fusion-bonded and/or pre-sintered parts.

In one embodiment, e.g., when the cast metal component is titanium or a predominantly titanium alloy, the elevated temperature in the HIP process can be from about 800° C. to about 1200° C., preferably from about 900° C. to about 1100° C., for example about 1000° C. The increased isostatic pressure can be from about 400 kg/cm² to about 2000 kg/cm², preferably from about 600 kg/cm² to about 1500 kg/cm², for example about 900 kg/cm².

While the period of time that a part is exposed to HIP can be tailored to the particular metal/alloy and/or the level of bulk flaw removal desired, inter alia, in one embodiment when the cast metal component is titanium or a predominantly titanium alloy, the period of exposure time at the elevated temperature and pressure can be from about 0.5 hours to about 5 hours, preferably from about 1 hour to about 4 hours, for example about 2 hours.

The “inert atmosphere” of the HIP process need only be relatively inert enough not to significantly degrade (e.g., oxidize and/or embrittle the surface of) the cast metal component. As such, the relatively inert atmosphere may include different gases, or even liquids, depending upon the chemistry of the metal/alloy used. In preferred embodiments, the cast metal component can advantageously be relatively or substantially impermeable to the relatively inert atmosphere, in order to achieve better bulk flaw removal and/or densification. Examples of relatively inert gases can include, but are not limited to, nitrogen, argon, helium, and xenon.

In general, the bulk flaw removal step substantially eliminates, or minimizes the impact of, flaws in the cast metal component that include, but are not limited to, voids, porosity, undesirable metallic and/or ceramic phases, dislocation stresses, and extensive grain boundaries.

After the bulk flaw removal step, the treated cast metal component exhibits increased and/or more consistent mechanical properties, such as tensile strength, flexural strength, toughness, impact resistance, low-cycle fatigue resistance, high-cycle fatigue resistance, creep life, strain-to-break, and rupture stress, among others.

For instance, a stainless steel alloy (17-4PH) part treated by HIP exhibited a fatigue endurance limit of about 52 ksi, as compared to about 29 ksi for a typical cast alloy piece not treated by HIP. In this case, the fatigue endurance limit was increased about 79% by using HIP. Additionally, in the case of a high-strength, low-alloy steel, a part treated by HIP exhibited an increased fatigue endurance limit of about 39 ksi, as compared to about 22 ksi for a typical cast alloy part not treated by HIP. In that case, the fatigue endurance limit was increased about 77% by using HIP. Furthermore, in the case of aluminum alloy 356, a part treated by HIP exhibited an increased fatigue endurance limit of about 15 ksi, as compared to about 8 ksi for a typical cast alloy part not treated by HIP. In that case, the fatigue endurance limit was increased about 87% by using HIP. It is typical for the tensile strength of a metal/alloy part treated with HIP to increase, as compared to a cast metal/alloy part not treated by HIP, but not as dramatically as for fatigue endurance limit. It is also typical for the tensile elongation of a metal/alloy part treated with HIP to approximately double, as compared to a cast metal/alloy part not subjected to HIP.

Hence, when a metal golf club, such as drivers, hitting face inserts, irons, and putters, is treated with HIP, the club's performances are improved. The clubs last longer and the ability of the hitting face to deform elasticity improves, thereby improving the coefficient of restitution of the impact between the ball and club.

While central zone 4 illustrated herein has a substantially rhombus shape, the present invention is not so limited. Central zones 4 having any geometrical shapes, such as oval, circular, elliptical any regular or irregular shape can be used and are within the scope of the appended claims.

While the method according to the invention typically makes use of a cast metal component, it is contemplated that metal components made using other metal forming techniques can additionally or alternately be used for forming the metal component starting material. For instance, instead of a metal component that is cast, the method according to the invention includes the use of metal sheet stock, or a cast metal component that has already been subjected to mechanical working (e.g., rolling). Nevertheless, in one embodiment, the metal component starting material can be made by a process that is substantially free from a metal binder. For example, in this embodiment, the metal component starting material can be made by a process other than metal injection molding. In another embodiment, the metal component starting material can be made by a process other than powder metallurgy (e.g., powdered metal sintering).

The specific type of golf club, golf club head, or portion thereof that can be made using the method according to the invention can include, but is not limited to, a driver, a metal wood, an iron, a putter, a head thereof, an insert for the club such as a face insert, cast body shell, or a combination thereof. In one embodiment, the method according to the invention is for forming a face insert for a club head of a metal wood.

While various descriptions of the present invention are described above, it should be understood that the various features of each embodiment could be used alone or in any combination thereof. Therefore, this invention is not to be limited to only the specifically preferred embodiments depicted herein. Further, it should be understood that variations and modifications within the spirit and scope of the invention might occur to those skilled in the art to which the invention pertains. For example, additional configurations and placement locations of the thin layer are contemplated. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

I claim:

1. A method for forming a cast metal component of a golf club comprising:
providing the cast metal component;
modifying the surface of the cast metal component to form a surface-modified cast metal component; and
treating the cast metal component in a hot isostatic pressing process to form a bulk-modified cast metal component.

2. The method according to claim 1, wherein the surface modification step comprises chemical milling.

3. The method according to claim 1, wherein the cast metal component is a club head insert, an iron club head, a driver club head, or a putter.

4. The method according to claim 1, wherein the cast metal component is made from stainless steel, titanium, or a titanium alloy.

5. The method according to claim 1, wherein the hot isostatic pressing process occurs at an elevated temperature, at an elevated pressure, in an inert atmosphere, and for a period of time, such that at least one of the following conditions is satisfied:
the elevated temperature is from about 800° C. to about 1200° C.;
the increased isostatic pressure is from about 400 kg/cm² to about 2000 kg/cm²;
the period of exposure time at the elevated temperature and pressure is from about 0.5 hours to about 5 hours; and
the inert atmosphere comprises argon.

6. The method according to claim 1, wherein the hot isostatic pressing step minimizes the impact of at least one of the following flaws in the cast metal component: voids, porosity, undesirable metallic phases, undesirable ceramic phases, dislocation stresses, extensive grain boundaries, and combinations thereof.

7. The method according to claim 1, wherein the bulk-modified cast metal component exhibits increases in at least one of the following mechanical properties: tensile strength, flexural strength, toughness, impact resistance, low-cycle fatigue resistance, high-cycle fatigue resistance, creep life, strain-to-break, rupture stress, and combinations thereof.

8. The method according to claim 1, wherein the surface modification step comprises a chemical mechanical polishing step.
